(19) United States
(12) Patent Application Publication
(10) Pub. No.: US 2024/0118494 A1
(43) Pub. Date: Apr. 11, 2024

(54) METHOD FOR MACHINING AN OPTICAL FIBRE, OPTICAL FIBRE, COUPLING ASSEMBLY AND MANUFACTURING ASSEMBLY

(71) Applicant: LASER ZENTRUM HANNOVER E. V., HANNOVER (DE)

(72) Inventors: FELIX WELLMANN, HANNOVER (DE); MATEUSZ WYSMOLEK, ST. GEORGEN (DE)

(73) Assignee: LASER ZENTRUM HANNOVER E. V., HANNOVER (DE)

(21) Appl. No.: 18/277,077

(22) PCT Filed: Feb. 14, 2022
(86) PCT No.: PCT/DE2022/200016

§ 371 Date: Aug. 14, 2023

(30) Foreign Application Priority Data
Feb. 16, 2021 (DE) 10 2021 103 603.8

(51) Int. Cl. G02B 6/28

(52) U.S. Cl. CPC G02B 6/2826

(57) ABSTRACT

A method of processing an optical fiber for coupling an external optical signal. The optical fiber has a longitudinal axis, an optical core, and an optical cladding. The method includes processing the optical cladding with a laser beam at a coupling point of the optical fiber along the longitudinal axis between a start and an end region. During the processing, an effective axis of the laser beam is arranged skew with respect to the longitudinal axis of the optical fiber so that the optical cladding is processed via an edge region of the laser beam, and the effective axis of the laser beam is guided along a movement axis which is parallel to or substantially parallel to the longitudinal axis of the optical fiber.

### CROSS REFERENCE TO PRIOR APPLICATIONS

This application is a U.S. National Phase application under 35 U.S.C. § 371 of International Application No. PCT/DE2022/200016, filed on Feb. 14, 2022 and which claims benefit to German Patent Application No. 10 2021 103 603.8, filed on Feb. 16, 2021. The International Application was published in German on Aug. 25, 2022 as WO 2022/174873 A1 under PCT Article 21(2).

### FIELD

The present invention relates to a method of processing an optical fiber for coupling an external optical signal, wherein the optical fiber comprises a longitudinal axis, at least one optical core, and an optical cladding and, for coupling the external optical signal, the optical cladding is processed at a coupling point of the optical fiber along the longitudinal axis between a start region and an end region via a laser beam. The present invention also relates to an optical fiber produced by such a method, to a coupling arrangement comprising a feed fiber, and to an optical fiber and a coupling site with such a fiber. The present invention additionally relates to a manufacturing arrangement for manufacturing a coupling point which is configured so that the above method can be performed.

### BACKGROUND

Various methods are known for processing an optical fiber for coupling an optical signal.

Hydrofluoric acid was historically used to remove areas of the fiber, for example, a cladding of the fiber, by etching. The use of hydrofluoric acid produced unclean surfaces of the optical fiber, however, with partly reduced optical and mechanical quality. There also exist health risks associated with this type of processing.

Mechanical technologies that use an abrasive or comparable means cannot be reliably applied to non-rotationally symmetrical optical fibers in particular since no selective ablation can be set. Abrasive substances are also present in this process which make it necessary to clean the optical fiber after the process.

Known methods using a laser for ablation or processing of an optical fiber radiate perpendicularly or at an angle similar to the perpendicular onto the respective optical fiber so that also no precise selective ablation, in particular within a cladding of the fiber, is possible.

### SUMMARY

An aspect of the present invention is to improve upon the prior art.

In an embodiment, the present invention provides a method of processing an optical fiber for coupling an external optical signal. The optical fiber includes a longitudinal axis, an optical core, and an optical cladding. The method includes processing the optical cladding via a laser beam at a coupling point of the optical fiber along the longitudinal axis between a start region and an end region. During the processing, an effective axis of the laser beam for the processing of the optical cladding is arranged skew with respect to the longitudinal axis of the optical fiber so that the optical cladding is processed via an edge region of the laser beam so as to generate an optical fiber having a coupling point for coupling-in the external optical signal. During the processing, the effective axis of the laser beam is guided along a movement axis which is parallel to or substantially parallel to the longitudinal axis of the optical fiber so as to process the coupling point of the optical cladding along the longitudinal axis.

### BRIEF DESCRIPTION OF THE DRAWINGS

The present invention is described in greater detail below on the basis of embodiments and of the drawings in which:

FIG. 1 shows a schematic representation of a so-called fiber amplifier with signal-pump coupler and cladding mode stripper;

FIG. 2 shows a schematic representation of an optical fiber with a concealed pump cladding in a sectional view;

FIG. 3 shows a schematic representation of the optical fiber of FIG. 2 in a cut side view with a coupling point;

FIG. 4 shows a schematic representation of a processing method for an optical fiber using a laser beam;

FIG. 5 shows a manufacturing arrangement for producing a coupling point on an optical fiber;

FIG. 6 shows an alternative arrangement for producing a coupling point analogous to FIG. 5 with an alternative travel line;

FIG. 7 shows an alternative manufacturing arrangement for producing a coupling point on an optical fiber; and

FIG. 8 shows a schematic representation of an optical fiber analogous to FIG. 3 in a cut side view with an alternative coupling point.

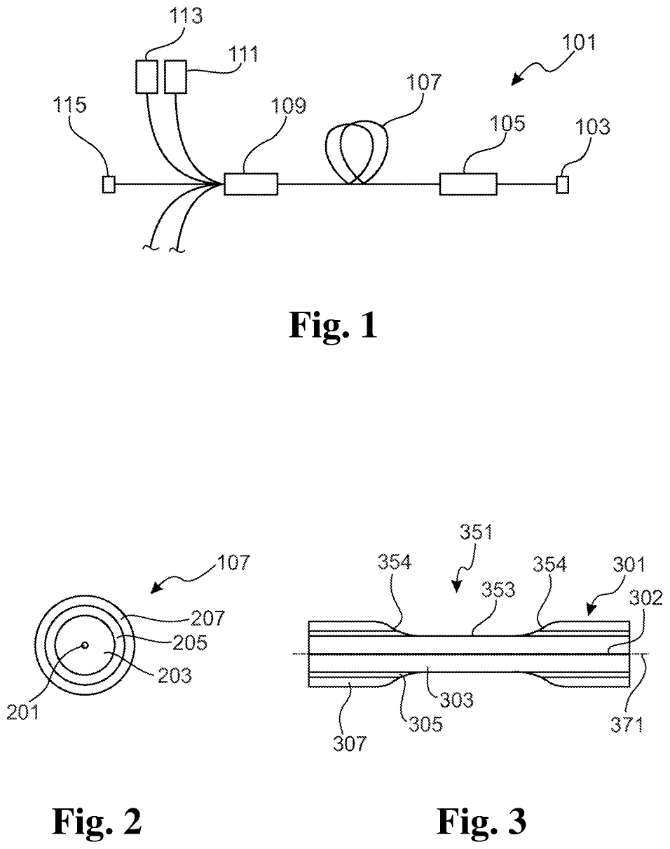

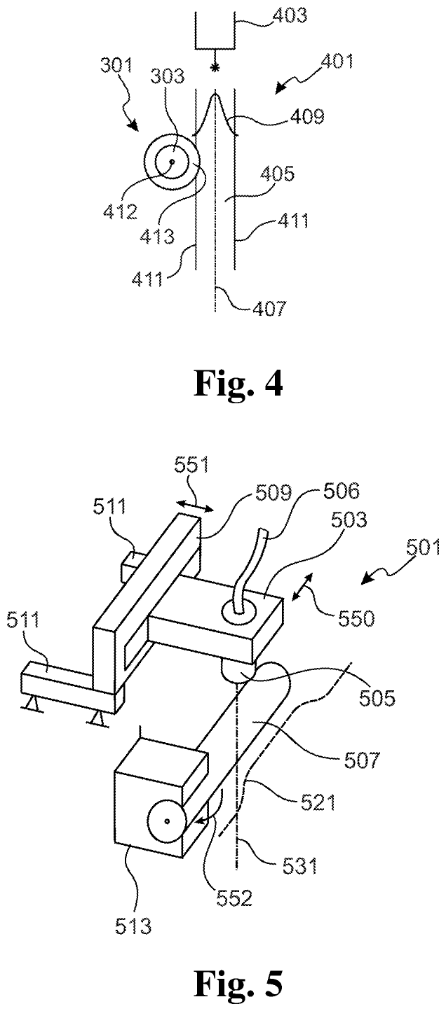

### DETAILED DESCRIPTION

The present invention provides a method of processing an optical fiber for coupling an external optical signal, wherein the optical fiber comprises a longitudinal axis, an optical core, and an optical cladding, and, for coupling the external optical signal, the optical cladding is processed at a coupling point of the optical fiber along the longitudinal axis between a start region and an end region via a laser beam, wherein an effective axis of the laser beam for processing the optical cladding is arranged skewed with respect to the longitudinal axis of the optical fiber so that the optical cladding is processed by an edge region of the laser beam and an optical fiber having a coupling point for coupling the external optical signal is generated, and the effective axis of the laser beam is guided along a movement axis which is parallel or substantially parallel to the longitudinal axis of the optical fiber so that the coupling point of the optical cladding is processed along the longitudinal axis.

With this procedure, the edge region of the laser beam can be uniformly and continuously approached laterally to the longitudinal axis of the optical fiber and guided along the optical fiber. This enables a uniform and reliable ablation and a precise processing of corresponding parts of the optical fiber. This is effected, for example, by melting a part of the optical fiber, namely, the optical cladding, or also by evaporation, vaporization, ablation and/or by burning of individual parts of the optical cladding. Access to the optical core of the optical fiber can thus then be provided.

Since a laser beam usually has a defined power distribution, for example, with a high power density in the region of a beam core or beam center and a decreasing power density in edge regions, these regions of decreasing power density or also regions of defined power density can additionally be used to bring about a uniform and “soft” onset of the corresponding processing with a smooth transition via the laser beam. This in particular occurs when the laser beam with a lower-energy edge region in its edge region is approached to the optical fiber and/or the optical cladding. A laser beam can, for example, have a power distribution according to a Gaussian distribution, a top-head distribution or a Bessel distribution.

The following terms should be explained at this point:

A “processing” of an optical fiber may be any degradation and/or modification of the optical fiber or a part of the optical fiber. Such a processing is, for example, a melting, smoothing, changing or also a removing and/or an ablating of a corresponding mass of the optical fiber so that, for example, the optical cladding of the optical fiber is melted and/or vaporized, or also removed by a so-called ablation. A single or multiple melting can here also be brought about to create a smoother surface and/or to smoothen corresponding regions of the optical fiber.

An “optical fiber” can be any fiber, for example, also known as an optical waveguide, made of a plastic, a glass or a comparable material. Such optical fibers are primarily used for data transmission or also for directing a laser pulse or laser beam, wherein information and/or energy in the form of light pulses is transported and transmitted within the optical fiber. Such an optical fiber is, for example, an optical fiber i.e., a long and thin fiber consisting of glass. Such an optical fiber comprises an optical core which serves to guide light, and an optical cladding which, inter alia, prevents light from escaping in that the optical cladding in particular has a different refractive index than the optical core or is completely or partially optically opaque, and thus also serves to guide light. The optical core and also the optical cladding can be completely transparent to light, in particular in the visible wavelength range.

“Coupling” of an external optical signal describes any introduction of an external optical signal into a data signal running in the optical fiber. Such a coupling can be additive or subtractive, or it can serve to amplify or reduce the optical signal or data signal that is originally transported in the optical fiber.

An “external optical signal” can be an additional information or also a data information or light information used for the so-called pumping of a signal. Such an external optical signal can also be used as a subtractive applied optical signal in the form of a so-called cladding mode stripper.

A “longitudinal axis” of the optical fiber describes an axis that extends along a longitudinal dimension of the optical fiber. The longitudinal axis need not extend mathematically exactly along a geometric or center-of-gravity axis of the optical fiber.

An “optical core” can be the part of the optical fiber in which an optical signal, for example, in the form of a light pulse, is transported and transmitted. Such an optical core is, for example, the pump cladding of an optical fiber.

An “optical cladding” can be any layer or coating located outside the optical core or any part of the optical fiber located outside the optical core, which in particular serves to prevent leakage of parts of the optical signal, for example, a light pulse, from the optical core. Such an optical cladding usually has a different refractive index than the optical core. This can be achieved by adding chemical elements such as fluorine. An optical cladding made of a material different from the optical core may also be applied to the optical core and form the optical cladding. The optical cladding can alternatively also be completely or partially opaque.

A “coupling point” of the optical fiber is any appropriately processed location of the optical fiber at which coupling of an external optical signal is enabled. Such a coupling point is, for example, a point of the optical fiber along the longitudinal axis at which the optical cladding has been processed, modified or removed so that the external optical signal can be introduced into the optical core.

A “start region” and an “end region” of this coupling point is in each case, for example, the region at which the coupling point transitions geometrically or also optically into the other previously existing configuration of the optical cladding. Such a start region or such an end region is, for example, a transition between a remote optical cladding and an optical cladding that exists outside the coupling point and is still present.

A “laser beam” is generally described as a coherent radiation source and is an electromagnetic wave or set of electromagnetic waves emitted from a so-called LASER (light amplification by stimulated emission of radiation). Such a laser beam is characterized primarily by a combination of high intensity, often in a very narrow frequency range, a sharp bundling of the beam and a large coherence length. Such a laser beam is ideally formed from a large number of parallel electromagnetic waves in a visible or non-visible range. Lasers in the infrared, visible and also ultraviolet light range are, for example, known. A laser beam can have a beam core, also called a beam center, in which a certain intensity of the laser beam prevails and which is surrounded by a peripheral area of the laser beam.

An “effective axis” of the laser beam describes, for example, the center axis of such a coherent light beam or a reference axis along which the laser beam propagates. This effective axis need not be exactly defined geometrically, but can be defined, for example, with technically usual deviations of, for example, −0.5° to +0.5°.

“Skew” defines the mathematical relation between two axes or two straight lines, wherein these two axes or two straight lines neither intersect nor are parallel to each other. Such skew lines do not form a common plane or do not lie in a common plane. In the present case, for example, the effective axis of the laser beam lies in relation to the longitudinal axis of the optical fiber in such a way that, figuratively speaking, the laser beam passes by the optical fiber and “touches” the optical fiber, for example, only with an edge region.

An “edge region” of the laser beam is, for example, a region of lower intensity compared to the intensity in a beam core or beam center of the laser beam. This is in particular the case if the energy density of the corresponding laser beam follows a normal distribution or a distribution similar to a normal distribution so that the highest intensity of the laser beam is present in its center and the intensity decreases towards the edge regions. Such an edge region can also be a geometrically defined region surrounding the beam core or the beam center.

In an embodiment of the present invention, the method is performed so that a relative rotation between the optical fiber and the effective axis of the laser beam about the longitudinal axis of the optical fiber can, for example, be performed during processing so that different circumferential regions of the processed coupling point of the optical fiber are processed.

This procedure provides that the optical fiber is processed along its circumference at different circumferential areas of the processed coupling point. Only desired circumferential areas of the processed coupling point can, for example, be selectively addressed with the laser beam. Uniform relative rotation, in particular rotation, of the optical fiber with respect to the laser beam can also be used to perform uniform processing around the full circumference of the coupling point.

A “circumferential region” is, for example, a surface on the circumference of the optical fiber, in particular of the coupling point, wherein this circumferential region can extend both in the direction along the longitudinal axis of the optical fiber and in the direction of a circumference. The effect can thus be used that a laser beam has a higher power density in its beam core or beam center, for example, than in its peripheral region. If the distance between the effective axis of the laser and the effective axis of the optical fiber is varied, the less power-dense edge regions of the laser beam are brought into contact with the optical fiber when the distance is increased, and thus less power is introduced into the optical cladding. This then decreases the processing power at the optical cladding. In contrast thereto, reducing the distance between the effective axis of the laser beam and the effective axis of the optical fiber due to the power distribution and the higher power in the core of the laser beam increases the power introduced into the optical cladding and thus also increases the processing power. A respective intervention in the processing power can thus be made very freely overall and also in conjunction with changing the power of the laser beam. The process can thus be very finely controlled.

If the movement axis is curved, arcuate and/or parabolic, both a smooth transition and a particularly uniform machining result can be achieved. It has surprisingly been shown that in particular with such an approach, a transition from an undisturbed and unprocessed area of the fiber to the coupling point can be achieved in a very defined and reproducible manner.

In order to be able to use the process flexibly and variably, a power of the laser beam is varied so that via the varied power of the laser beam it is possible to change a processing power at the optical cladding.

An increased power of the laser beam can thus, for example, enable a stronger processing or also a stronger ablation of the optical cladding or another part of the optical fiber, so that, in contrast, a more uniform and careful or also controlled or selective processing or ablation of the optical cladding is enabled with a reduced power.

The “power” of the laser beam describes, for example, an energy density of the laser beam per reference area, a brightness of the laser beam or a transferred energy of the laser beam to the optical cladding and/or the optical fiber.

In an embodiment of the present invention, the distance of the effective axis of the laser beam to the longitudinal axis of the optical fiber can, for example, be changed at the start region and/or at the end region of the coupling point so that a uniform geometric and/or optical transition of the coupling point to the optical fiber is produced.

The optical cladding can be processed and/or also removed along the longitudinal axis of the optical fiber with this procedure in a uniform and easily controllable manner. Soft and uniform transition regions from the coupling point to the unprocessed optical fiber can be created by changing the distance of the effective axis of the laser beam at the start region and/or at the end region, in particular by removing the effective axis of the laser beam from the longitudinal axis of the optical fiber.

In an embodiment of the present invention, the distance of the effective axis at the start region and/or at the end region of the coupling point is changed so that a connection surface and/or an insertion surface, in particular at the optical cladding, is formed at an angle of 0.01° to 90°, in particular at an angle of 0.01° to 60°, for example, at an angle of 0.01° to 10°, relative to the longitudinal axis. An angle can, for example, be realized that results from a length of the coupling point of 20 mm and an ablation of the fiber cladding of 25 μm, i.e., rounded to about 0.07°.

Via this “connection surface” or also “insertion surface” arranged at the angle opposite the coupling point, the regions of the coupling point can be clearly delimited and created in a geometrically defined manner so that, for example, the connection of a further optical fiber for the introduction of the external optical signal is possible in a geometrically defined manner. Angle specifications in this context refer to a full angle of 360°.

In order to be able to perform the method with as precise an effect as possible and with good controllability, the effective axis of the laser beam and the longitudinal axis of the optical fiber are arranged at an angle of 45° to 135°, in particular 60° to 120°, for example, 85° to 95°, or at right angles to each other. Reflection effects and deflection effects are thereby in particular reduced or defocusing effects of the laser beam within the processing zone of the coupling point are suppressed or also specifically exploited.

In another embodiment of the present invention, the laser beam can, for example, be generated by a solid-state laser and/or a gas laser, in particular a CO₂ laser, a CO laser, an ultrashort pulse laser, an excimer laser or a titanium sapphire laser.

Such respective lasers are available on the market and can therefore be integrated into the method inexpensively and with technical reliability.

In a further aspect, the present invention provides an optical fiber having a coupling point for coupling an external optical signal, which is manufactured via a method according to the embodiments described above.

Such an optical fiber may have a coupling point which is produced via the method of the present invention in a uniform, defined and repeatable manner, wherein an external optical signal can be coupled into the optical fiber reliably and with little effort.

In a further aspect, the present invention provides a coupling arrangement comprising a feed fiber, an optical fiber and a coupling point for transmitting an optical signal from a feed fiber into an optical fiber, wherein the feed fiber introduces the optical signal into the optical fiber at the coupling point and the optical fiber is implemented according to the aforementioned type. The feed fiber is, for example, welded to the optical fiber at the coupling point therefor.

Such a coupling arrangement provides a reliable and a low-loss transmission of an optical signal from a feed fiber into an optical fiber.

The following terms shall be explained at this point:

A “feed fiber” is an optical fiber that is used to introduce an optical signal, such as an external optical signal as described above, into the coupling arrangement and to couple and/or introduce it into the optical fiber.

The “transfer” of an optical signal from a feed fiber into an optical fiber is equivalent to the coupling of this signal, for example, the external optical signal, as indicated above.

In another aspect, the present invention provides a manufacturing arrangement for producing a coupling point for coupling an external optical signal into an optical fiber having a fiber receptacle and a laser receptacle, wherein the optical fiber comprises a longitudinal axis, an optical core and an optical cladding, and, for coupling the external optical signal, the optical cladding is processed at a coupling point of the optical fiber along the longitudinal axis between a start region and an end region via a laser beam, and a fiber receiving axis of the fiber receptacle and a laser receiving axis of the laser receptacle are arranged at an angle to each other, so that a method according to the embodiments described above can be performed.

A “fiber receptacle” may be any mechanical or semi-mechanical arrangement that is suitable for holding an optical fiber and keeping it reliably and, in particular, firmly in place in the manufacturing arrangement and thus fixed and ready for processing.

A “laser receptacle” may be any device, particularly mechanical, for securely and reliably receiving a laser for generating a laser beam in the manufacturing arrangement and positioning and holding it relative to the optical fiber positioned in the fiber receptacle.

In this regard, a “fiber receiving axis” is, for example, a longitudinal axis of the fiber receptacle which, in the case of a received optical fiber, is parallel or substantially parallel to the longitudinal axis of the optical fiber and thus defines the longitudinal axis of the optical fiber within the manufacturing arrangement.

A “laser receiving axis” of the laser receptacle is analogously an axis that extends, for example, through the laser receptacle so that it is parallel or substantially parallel to the effective axis of the laser beam of a laser positioned and received in the laser receptacle.

The fiber receiving axis and the laser receiving axis are arranged at an angle to each other so that the process described above can be reliably performed with the laser beam inserted at an angle with respect to the longitudinal axis of the optical fiber.

The present invention is explained in greater detail below with reference to examples of embodiments as shown in the drawings.

A fiber amplifier 101 includes a signal input 103, a cladding mode stripper 105, and an optical fiber 107. The fiber amplifier 101 further comprises a signal pump coupler 109 with a pump diode 111 and a pump diode 113. The fiber amplifier 101 is also provided with a signal output 115.

The optical fiber 107 is an optical fiber having a fiber core 201, a pump cladding 203 arranged around the fiber core 201, and a cladding 205 applied to the pump cladding 203, and a plastic cladding 207 which is applied thereto. The pump cladding 203 serves to pass optical signals, such as light pulses, within the optical fiber 107. The cladding 205 serves to optically enclose the pump cladding 203. The plastic cladding 207 serves to protect the optical fiber 107. The pump cladding 203 and the cladding 205 are each made of glass so that the optical fiber 107 is also referred to as a “glass fiber”. The cladding 205 has a different optical refractive index than the pump cladding 203. This prevents an optical signal from being carried out of the pump cladding 203 to the outside, thus reducing the transmission power within the optical fiber 107.

The optical fiber 107 is provided with a coupling point inside the cladding mode stripper 105 and the signal pump coupler 109.

One such coupling point is exemplified by a fiber section 301.

Like the optical fiber 107, a fiber section 301 comprises a fiber core 302, a pump cladding 303, and a cladding 305 and a plastic cladding 307, as well as a longitudinal axis 371. In the region of a coupling point 351, the plastic cladding 307 and the cladding 305 are removed from the pump cladding 303 of the fiber section 301 to form a coupling region 353, thereby exposing the pump cladding 303. The coupling region 353 is geometrically and optically connected to the other regions of the fiber section 301 with outlet regions 354, so that a uniform optical transition is provided.

An external optical signal may thus be introduced at the coupling point 351 into the coupling region 353, such as pump radiation to modify or amplify an optical signal conducted in the fiber section 301 or analogously in the optical fiber 107.

A processing 401 for the fiber section 301 to create the coupling region 353 and thus the coupling point 351 is performed as follows:

The processing 401 is performed by a laser 403, which emits a laser beam 405. A center axis 407 of the laser beam 405 thus lies at an angle to a center axis 412 of the fiber section 301. The laser beam 405 has a distribution 409 that describes the energy density of the laser beam 405 at a corresponding distance from the center axis 407. The energy density of the laser beam 405 is thereby greatest at the center axis 407 and decreases toward a respective edge 411.

During processing 401, the edge 411 is brought into overlap with a cladding 413 of the fiber section 301. The cladding 413 corresponds to the cladding 305 and the plastic cladding 307, which are shown together here for clarity.

The laser beam 405 thus acts on the cladding 413, and thus on the cladding 305 and the plastic cladding 307, and can melt and vaporize it. The distance of the center axis 407 can be finely adjusted in processing intensity by moving the laser 403 toward the fiber section 301 as well as away from the fiber section 301. This is in particular promoted by taking advantage of the distribution 409 and the resulting decreasing power densities of the laser 403 and thus of the laser beam 405 towards the edge regions.

A manufacturing arrangement 501 is used to carry out the processing 401. The manufacturing arrangement 501 comprises a laser holder 503 in which a laser module 505 is held. The laser module 505 comprises a cable 506 via which the laser module 505 is controlled and supplied with power.

An optical fiber 507 is enclosed and locally fixed in a fiber holder 513. The optical fiber 507 is shown as an example and corresponds in its structure to the optical fiber 107 and the fiber section 301. The laser holder 503 with the laser module 505 is mounted on a longitudinal slide 509 and a transverse slide 511. The longitudinal slide 509 as well as the transverse slide 511 are shown exemplarily for an x-y adjustment of the laser holder 503 and thus of the laser module 505.

In an alternative, the laser module 505 can also be displaced in the laser holder 503 by piezo actuators or other actuator technology. A longitudinal displacement 550 can thus be triggered via the longitudinal slide 509. A transverse displacement 551 can be triggered via the transverse slide 511. The laser module 505 and a beam axis 531 of the laser module 505 can thus be moved freely relative to the optical fiber 507.

In the shown example, the laser holder 503 with the laser module 505 is moved so that the beam axis 531 is moved along a trough-shaped travel line 521. The optical fiber 507 is subjected to a rotational movement 552 during this process. The drive device for realizing this rotational movement is not shown.

If the optical fiber 507 is continuously subjected to the rotational movement 552 while moving the laser module 505 so that the beam axis 531 is moved along the travel line 521, the result is that the cladding of the optical fiber 507 is ablated so that a coupling point analogous to the coupling point 351 of the fiber section 301 is formed.

For the optical fiber 107, the fiber section 301 or a fiber section 701 (see below) as well as the optical fiber 507, the cladding is thereby partially vaporized in each case as well as also continuously melted and solidified during a respective rotational movement of the respective optical fiber and/or the respective optical fiber or fiber, so that a particularly smooth and flat surface is produced in the coupling region, for example, in the coupling region 353.

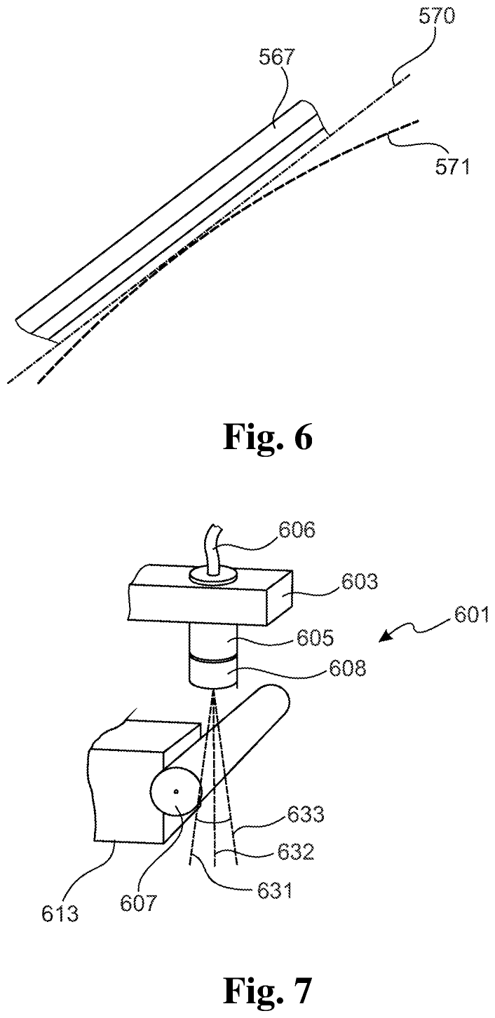

The travel line can alternatively also be configured as a curved, arcuate or parabolic travel line 571, as shown on a glass fiber 567 in relation to a parallel line 570 to the glass fiber 576 (see FIG. 6). This curved, arcuate or parabolic configuration of the travel line 571 creates a particularly uniform and defined coupling point at the glass fiber 567.

Depending on the configuration, this process can thus be used to create a particularly even, uniform and reliable coupling point.

In another alternative manufacturing arrangement 601 (see FIG. 7), the basic structure of which between laser and optical fiber corresponds to the previous example, an optical fiber 607 is received in a fiber holder 613 and a laser module 605 is received in a laser holder 603. The laser module 605 comprises an additional optics 608, so that via the optics 608 the laser beam of the laser module 605 can be guided. Different beam axes 631, 632 and 633 as well as any other steel axes can thus be realized without a mechanical positioning of the laser itself. The optical fiber can thus be guided without a mechanical positioning of the laser module 605 itself, but with the optics 608 for processing the optical fiber 607. The processing is carried out in each case analogously to the previous example.

Alternatively or additionally, as is common in laser technology, the manufacturing arrangements 501 and 601 may comprise lenses, mirrors, galvos, and also exhaust and inert gas devices to guide or shape the laser beam or to protect a processing zone.

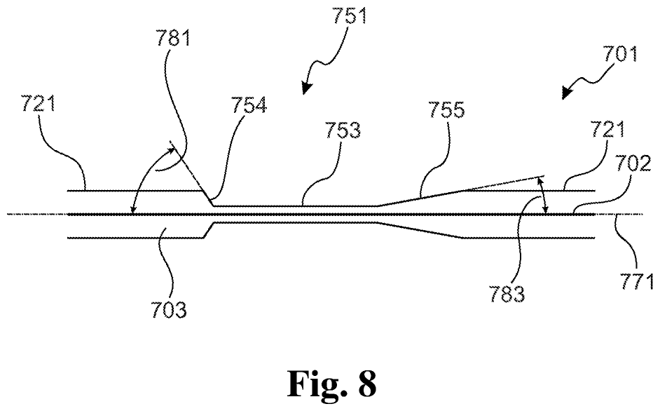

Like the optical fiber 107 and analogous to the fiber section 301, a fiber section 701 comprises a fiber core 702 and a pump cladding 703 as well as a longitudinal axis 771. In the region of a coupling point 751, material is removed from the pump cladding 703 of the fiber section 701 to form a coupling region 753, and the pump cladding 703 is thus partially removed. The coupling region 753 is geometrically connected to undisturbed regions 721 of the fiber section 701 by an outlet region 754 and an inlet region 755 with sharp edges at respective angles 781 and 783 within the scope of technical possibilities, so that a clearly delimited optical transition is provided. In the present example, the angle 781 for the outlet region is about 5°, the angle 783 about 0.5° (the representation in FIG. 8 is clearly overdrawn in each case for reasons of visibility).

At the coupling point 751, an external optical signal can thus be introduced into the coupling region 753 and/or into the inlet region 755, for example, pump radiation to modify or amplify an optical signal conducted in the fiber section 701 or analogously to an optical signal conducted in the optical fiber 107.

The present invention is not limited to embodiments described herein; reference should be had to the appended claims.

### LIST OF REFERENCE NUMERALS

101 Fiber amplifier
103 Signal input
105 Cladding Mode Stripper
107 Optical fiber
109 Signal pump coupler
111 Pump diode
113 Pump diode
115 Signal output
201 Fiber core
203 Pumping cladding
205 Cladding
207 Plastic cladding
301 Fiber section
302 Fiber core
303 Pump cladding
305 Cladding
307 Plastic cladding
351 Coupling point
353 Coupling region
354 Outlet region(s)
371 Longitudinal axis
401 Processing
403 Laser
405 Laser beam
407 Center axis
409 Distribution
411 Edge
412 Center axis
413 Cladding
501 Manufacturing arrangement
503 Laser holder
505 Laser module
506 Cable
507 Optical fiber
509 Longitudinal slide
511 Traverse slide
513 Fiber holder
521 Travel line
531 Beam axis
550 Longitudinal displacement
551 Transverse displacement
552 Rotational movement
567 Glass fiber
570 Parallel line
571 Travel line
601 Manufacturing arrangement
603 Laser holder
605 Laser module
606 Cable
607 Glass fiber
608 Optics
613 Fiber holder
631 Beam axis
632 Beam axis
633 Beam axis
701 Fiber section
702 Fiber core
703 Pump cladding
721 Undisturbed region
751 Coupling point
753 Coupling region
754 Outlet region
755 Inlet region
771 Longitudinal axis
781 Angle
783 Angle

What is claimed is:

1-11. (canceled)

12: A method of processing an optical fiber for coupling an external optical signal, wherein the optical fiber comprises,
a longitudinal axis,
an optical core, and
an optical cladding,
the method comprising:
processing the optical cladding via a laser beam at a coupling point of the optical fiber along the longitudinal axis between a start region and an end region,
wherein,
during the processing, an effective axis of the laser beam for the processing of the optical cladding is arranged skew with respect to the longitudinal axis of the optical fiber so that the optical cladding is processed via an edge region of the laser beam so as to generate an optical fiber having a coupling point for coupling-in the external optical signal, and
during the processing, the effective axis of the laser beam is guided along a movement axis which is parallel to or substantially parallel to the longitudinal axis of the optical fiber so as to process the coupling point of the optical cladding along the longitudinal axis.

13: The method as recited in claim 12, further comprising:
performing a relative rotation between the optical fiber and the effective axis of the laser beam about the longitudinal axis of the optical fiber during the processing so that different circumferential regions of the coupling point of the optical fiber are processed.

14: The method as recited in claim 12, further comprising:
varying a distance of the effective axis of the laser beam to the longitudinal axis of the optical fiber to thereby change a processing power at the optical cladding via the distance varied,
wherein,
the movement axis is configured in at least one of a curved manner, an arcuate manner, and a parabolic manner, so that the effective axis is guided along the longitudinal axis at a continuously varied distance.

15: The method as recited in claim 12, further comprising:
changing a distance of the effective axis of the laser beam to the longitudinal axis of the optical fiber at least one of at the start region and at the end region of the coupling point so as to produce at least one of a uniform geometric transition and a uniform optical transition of the coupling point to the optical fiber.

16: The method as recited in claim 15, wherein the distance of the effective axis at least one of at the start region and at the end region of the coupling point is changed so as to form at least one of a connection surface and an insertion surface at an angle of 0.01° to 90° with respect to the longitudinal axis.

17: The method as recited in claim 16, wherein the distance of the effective axis at least one of at the start region and at the end region of the coupling point is changed so as to form at least one of the connection surface and the insertion surface at the optical cladding at an angle of 0.01° to 10° with respect to the longitudinal axis.

18: The method as recited in claim 12, wherein the effective axis of the laser beam and the longitudinal axis of the optical fiber are arranged at an angle of 45° to 135° or at right angles to each other.

19: The method as recited in claim 12, wherein the effective axis of the laser beam and the longitudinal axis of the optical fiber are arranged at an angle of 85° to 95° to each other.

20: The method as recited in claim 12, wherein the laser beam is generated by a solid-state laser, a gas laser, a CO₂ laser, a CO laser, an ultrashort pulse laser, an excimer laser or a titanium-sapphire laser.

21: The method as recited in claim 12, further comprising:
varying a power of the laser beam so as to vary a processing power at the optical cladding.

22: A coupling arrangement comprising:
a feed fiber;
an optical fiber; and
a coupling point for transmitting an optical signal from the feed fiber into the optical fiber,
wherein
the feed fiber at least one of introduces the optical signal into the optical fiber at the coupling point and is connected to the optical fiber, and
the optical fiber is processed as recited in claim 21.

23: An optical fiber comprising a coupling point for coupling an external optical signal, the optical fiber which is produced by the method as recited in claim 12.

24: A manufacturing arrangement for manufacturing a coupling point for coupling an external optical signal into an optical fiber, the manufacturing arrangement comprising:
a fiber receptacle comprising a fiber receiving axis; and
a laser receptacle comprising a laser receiving axis,
wherein,
the optical fiber comprises,
a longitudinal axis,
an optical core, and
an optical cladding, and
for coupling the external optical signal,
the optical cladding is processed at the coupling point of the optical fiber along the longitudinal axis between a start region and an end region via a laser beam, and
the fiber receiving axis of the fiber receptacle and the laser receiving axis of the laser receptacle are arranged skewed to each other so that the optical fiber is subjectable to a rotational movement about the fiber receiving axis so as to perform the method as recited in claim 12.
